(19) United States
(12) Patent Application Publication
(10) Pub. No.: US 2011/0109969 A1
(43) Pub. Date: May 12, 2011

(54) LENS BARREL HAVING LIGHT PATH

(75) Inventor: Mamoru OGASAWARA, Saitama (JP)

(73) Assignee: FUJIFILM CORPORATION, Tokyo (JP)

(21) Appl. No.: 12/939,585

(22) Filed: Nov. 4, 2010

(30) Foreign Application Priority Data
Nov. 6, 2009 (JP) 2009-255175

(51) Int. Cl. G02B 27/00

(52) U.S. Cl. 359/601

(57) ABSTRACT

A lens barrel includes a barrel body for passing incident light along an optical axis. An aperture wall is disposed on an inner surface of the barrel body to project toward the optical axis, for defining a light path of the incident light for shielding outside the optical path. A front surface is formed on the aperture wall on an entrance side, and inclined with a decreasing diameter toward the entrance side with respect to the optical axis. Preferably, the front surface is finished with non-glossy matte finish. Furthermore, a lens holder is contained in the barrel body, has the light path extending through, for holding a lens therein. Furthermore, at least two lenses/lens groups are contained in the barrel body, arranged in the light path, for constituting a lens optical system. The aperture wall is disposed between the two lenses/lens groups.

### BACKGROUND OF THE INVENTION

1. Field of the Invention

The present invention relates to a lens barrel having light path. More particularly, the present invention relates to a lens barrel in which ghost, flare and other unwanted component of light can be suppressed in a light path.

2. Description Related to the Prior Art

A lens barrel is widely used in an optical instrument, such as a camera and microscope. There occurs ghost or flare when light is reflected inside the lens barrel. Strength of the ghost or flare is higher according to the strength of the light entering the lens barrel, to degrade an object image by lowering its sharpness considerably. To solve such a problem, there is a known technique of forming projections on an inner surface of the lens barrel to suppress travel of unwanted reflected light through the lens barrel. However, it is difficult to prevent reflection of light at side lines of tips of the projections, namely at angular portions. JP-A 7-020368 discloses a method of reducing the reflection at the side lines. There are large projections and small projections, arranged alternately to project from the inner surface of the lens barrel, and having a triangular shape as viewed in a section. Also, U.S.P. Pub. No. 2007/291,386 (corresponding to JP-A 2007-304466) discloses the lens barrel in which plural fine projections/recesses are formed on the inner surface of the lens barrel, and arranged in a pattern at a period equal to or smaller than a wavelength of incident light.

However, the light shielding of JP-A 7-020368 is performed by shielding the reflected light from the small projections by use of the large projections. There is no suggestion of shielding the reflected light from the large projections. In the method of U.S.P. Pub. No. 2007/291,386 (corresponding to JP-A 2007-304466), the projections/recesses for the inner surface must be smaller than a wavelength of the object light. If the lens barrel is for photography, the projections/recesses must be smaller than the wavelength of 400 nm of visible purple light. It is impossible to form the projections/recesses by well-known methods such as cutting. Such a structure is used on the inner surface where light in the lens barrel impinges obliquely, but is not used at portions of the aperture or lens holder where the light impinges directly.

In FIG. 13, light is converged in an aperture 11 or a portion of a light path 12 near to the aperture 11, namely inner wall of a lens holder. Thus, a reflected component of light is strong. Reflected light 13 or 14 is reflected again by lens optics 15 or an aperture stop plate 16, to cause ghost or flare as an unwanted image on a focal plane 17. For example, a special type of camera is carried on an artificial satellite, and frequently photographs images of the sun, clouds illuminated by the sun, and the like. Brightness of light of such objects is very high. Occurrence of ghost, flare and the like must be prevented before images of objects can be photographed, because unwanted reflection of the light of high brightness must be eliminated in the lens barrel.

### SUMMARY OF THE INVENTION

In view of the foregoing problems, an object of the present invention is to provide a lens barrel in which ghost, flare and other unwanted component of light can be suppressed in a light path.

In order to achieve the above and other objects and advantages of this invention, a lens barrel includes a barrel body for containing a lens. A first aperture wall is disposed in front of the lens, formed to project from an inner surface of the barrel body toward an optical axis of the lens, for defining a light path of incident light, and for light shielding outside the light path. A first front surface is formed on the first aperture wall on an entrance side annularly, and inclined with a decreasing diameter toward the entrance side with respect to the optical axis.

The first front surface is finished with non-glossy matte finish.

Furthermore, a focusing lens is contained in the barrel body in front of the lens, wherein the first aperture wall is disposed between the lens and the focusing lens.

Furthermore, there is a second aperture wall for light shielding between a periphery of the lens and the inner surface.

Furthermore, a second front surface is formed on the second aperture wall on the entrance side annularly, and inclined in a direction in which the first front surface is inclined.

In one preferred embodiment, furthermore, a second front surface is formed on the second aperture wall on the entrance side annularly, and shaped in a locally bent form as viewed in a section. The second front surface has a combination of an annular surface aligned with the optical axis and an inclined surface inclined relative to the optical axis, or a combination of two inclined surfaces inclined relative to the optical axis in directions opposite to one another.

The second aperture wall is a corrugated sheet.

Furthermore, a regulating ring is disposed behind the corrugated sheet, for firmly contacting an end of a support portion of the corrugated sheet for supporting the lens. A through opening is formed in the inclined surface, for causing attenuation of entered stray light between the regulating ring and the corrugated sheet.

In another preferred embodiment, furthermore, a plurality of pin-shaped projections are formed on a surface of the second aperture wall on the entrance side, and having a decreasing width toward the entrance side.

Also, a lens barrel is provided, and includes a barrel body for containing a lens. An aperture wall defines a light path through a center of the barrel body, for light shielding outside the light path. A front surface is formed on the aperture wall on an entrance side annularly, and inclined with a decreasing diameter toward the entrance side.

Also, a lens barrel includes a barrel body for passing incident light along an optical axis. An aperture wall defines a light path of the incident light within the barrel body for shielding outside the optical path. An annular surface is formed erectly from the aperture wall on the entrance side, to extend annularly about the optical axis. An inclined surface is disposed on the aperture wall on the entrance side, to extend from an end point of the annular surface on an exit side, with an inclination, and annularly about the optical axis, for defining an annular groove with the annular surface.

The inclined surface has a decreasing diameter toward the entrance side with respect to the optical axis.

The aperture wall is constituted by an aperture sheet, and the annular and inclined surfaces are formed by corrugating the aperture sheet.

The inclined surface is finished with non-glossy matte finish.

Furthermore, a through opening is formed in the annular or inclined surface.

In another preferred embodiment, furthermore, a lens holder holds a lens therein, and constitutes the aperture wall, the lens holder having the annular and inclined surfaces.

Furthermore, a plurality of pin-shaped projections are formed on a front surface of the aperture wall on the entrance side, and respectively have the annular and inclined surfaces.

Also, a lens barrel includes a barrel body for passing incident light along an optical axis. An aperture wall defines a light path of the incident light within the barrel body for shielding outside the optical path. A plurality of pin-shaped projections are formed on a front surface of the aperture wall on the entrance side, and have a decreasing width toward the entrance side.

The pin-shaped projections have a surface finished with non-glossy matte finish.

Therefore, it is possible to provide the lens barrel in which ghost, flare and other unwanted component of light can be suppressed in a light path.

### BRIEF DESCRIPTION OF THE DRAWINGS

The above objects and advantages of the present invention will become more apparent from the following detailed description when read in connection with the accompanying drawings, in which:

FIG. 1 is a vertical section illustrating a lens barrel;

FIG. 2 is a vertical section illustrating a state of stray light in the lens barrel;

FIG. 3 is an explanatory view in a vertical section illustrating attenuation of the stray light on an aperture wall;

FIG. 4 is an explanatory view in a vertical section illustrating attenuation of the stray light on an inclined surface of a lens holder;

FIG. 5 is an explanatory view in a vertical section illustrating one preferred aperture wall with two inclined surfaces;

FIG. 6 is a vertical section illustrating another preferred aperture wall in which an aperture sheet is in a corrugated form;

FIG. 7 is an exploded view in a vertical section illustrating a lens holder with the aperture sheet;

FIG. 8A is a front elevation illustrating one preferred embodiment with through openings formed in the aperture sheet;

FIG. 8B is a vertical section illustrating the preferred embodiment;

FIG. 9 is an explanatory view illustrating a state of stray light with the aperture sheet;

FIG. 10 is a vertical section illustrating still another preferred lens barrel in which pin-shaped projections are arranged on an aperture wall;

FIG. 11A is a vertical section illustrating a lens holder in the lens barrel;

FIG. 11B is a front elevation illustrating the lens holder;

FIG. 12 is a vertical section illustrating one preferred lens barrel including an auxiliary sleeve for support; and

FIG. 13 is a vertical section illustrating a lens barrel of the prior art.

### DETAILED DESCRIPTION OF THE PREFERRED

### Embodiment(s) of the Present Invention

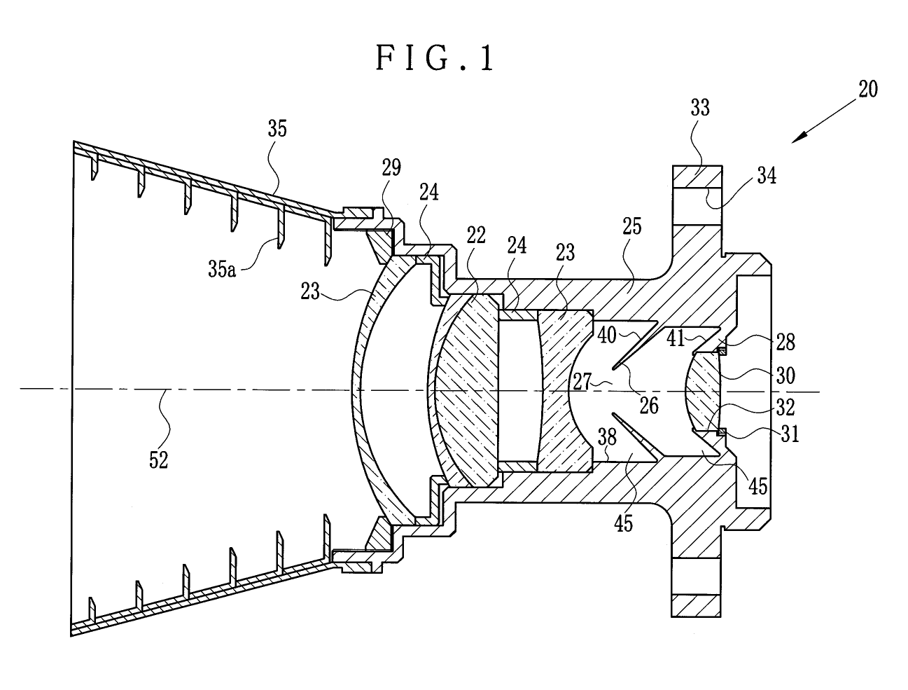

In FIG. 1, a lens barrel 20 of the invention includes a barrel body 25 and an aperture wall 26 for shielding light. There is an inner surface 38 from which the aperture wall 26 projects. An aperture 27 is defined in the aperture wall 26 and about an optical axis 52. External light is incident in the aperture wall 26, and passed through the aperture 27 toward an exit side of the lens barrel 20. A lens holder 28 is positioned on the optical axis 52 inside the inner surface 38 of the barrel body 25. A light path 32 or inner wall is defined to extend through the lens holder 28. A lens/lens group 30 or lens optics is held by the lens holder 28. A front surface 40 of the aperture wall 26 and an inclined surface 41 of the lens holder 28 extend in a form of a frustum of a cone. A retaining ring 31 firmly retains the lens/lens group 30 positioned in the light path 32.

A V shaped groove 45 is formed in the lens holder 28 between the front surface 40, the inclined surface 41 and the inner surface 38, and defines a doughnut shaped cavity of which a form in a section is a wedge shape. The front surface 40 and the inclined surface 41 are finished with non-glossy matte finish to reflect light in a scattered manner with low reflectivity. For example, the barrel body 25 is processed in alumite processing if formed from aluminum, and processed in ion plating if formed from titanium. The lens optical system has a plurality of lenses/lens groups 23 or lens optics, including the lens/lens group 30 a lens doublet 22, and a focusing lens. Spacers 24 or rings are inserted between the lenses/lens groups 23 and contained in the barrel body 25. A retaining ring 29 keeps the lenses/lens groups 23 positioned fixedly. The barrel body 25 includes a support flange 33 and a support hole 34 disposed on the exit side. A lens hood 35 is removably secured to an entrance end of the barrel body 25 for removing unwanted components of light.

Annular ridges 35a are formed inside the lens hood 35 for blocking light, and have a height increasing in the direction toward the exit side.

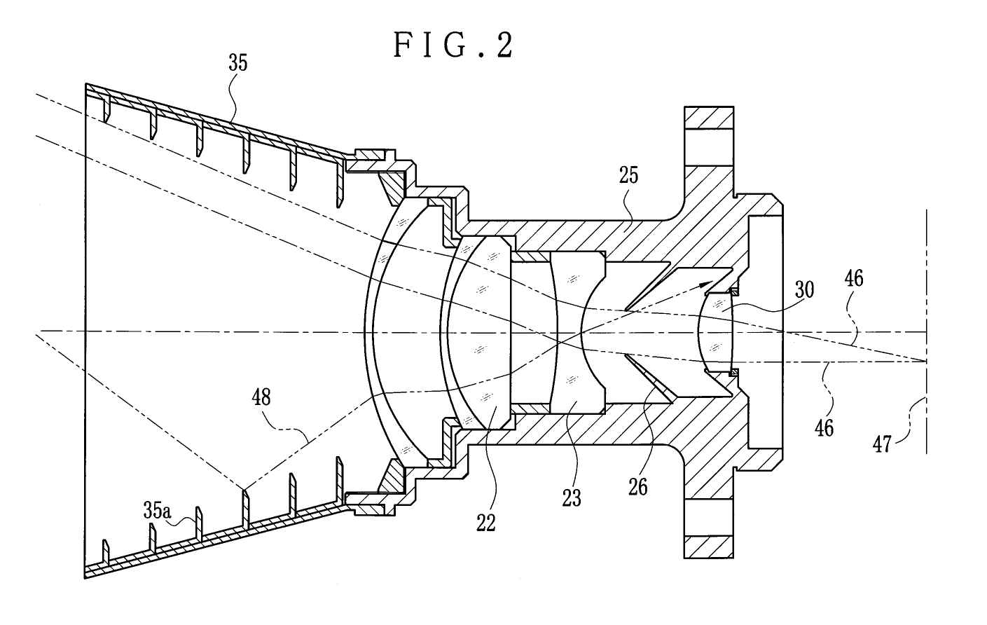

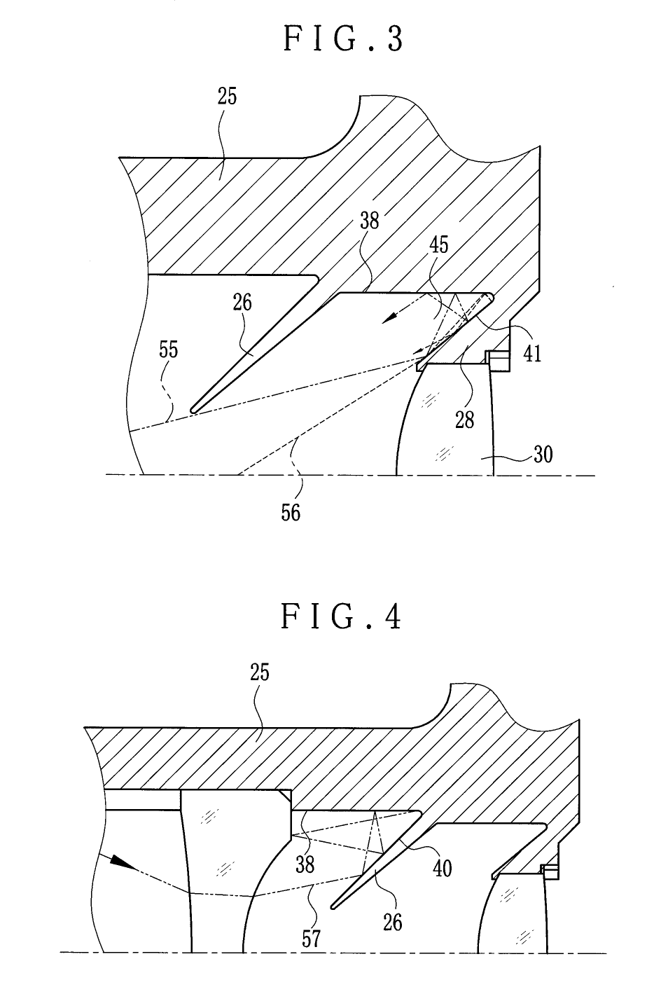

The operation of the lens barrel 20 is described now. In FIG. 2, incident light 46 passing properly is focused on a focal plane 47. Stray light 48 directed by reflection at one of the annular ridges 35a inside the lens hood 35 will not be focused on the focal plane 47. In FIG. 3, stray light 55 and 56 having passed the aperture 27 impinges on the inclined surface 41 on the entrance side of the lens holder 28. Reflected components in attenuation impinge on the inner surface 38. The components are further attenuated and impinge on the inclined surface 41. In short, inner surfaces of the V shaped groove 45 in the V shape repeatedly reflect the light for attenuation. No ghost or flare will occur because of considerable weakness of the reflected components even upon reach at the focal plane 47.

In FIG. 4, incident light 57 traveling toward the aperture wall 26 impinges on the front surface 40 of the aperture wall 26, is attenuated, scattered and reflected, and impinges on the inner surface 38. Again, the incident light 57 from the inner surface 38 impinges on the front surface 40. Thus, the V shaped groove 45 is effective in attenuating the incident light 57 by reflection. Unwanted effects such as ghost, flare and the like can be prevented because the incident light 57 is considerably weakened even upon reach to the focal plane 47.

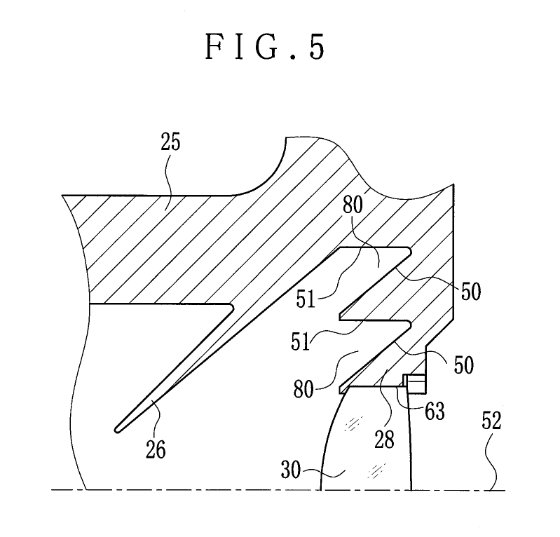

In FIG. 5, one preferred embodiment for light shielding around the lens is illustrated. A plurality of inclined surfaces 50 and a plurality of annular surfaces 51 are arranged about the optical axis 52, and have inclinations different from one another with respect to the optical axis 52. Annular grooves 80 are defined by combinations of the inclined surfaces 50 and the annular surfaces 51, and have a V shape as viewed in a cross section. A direction of the annular surfaces 51 may be parallel to the optical axis 52 as depicted in the drawing, but may be inclined reverse to the inclined surfaces 50. The number of the combinations of the inclined surfaces 50 and the annular surfaces 51 is two, but may be three, four or more.

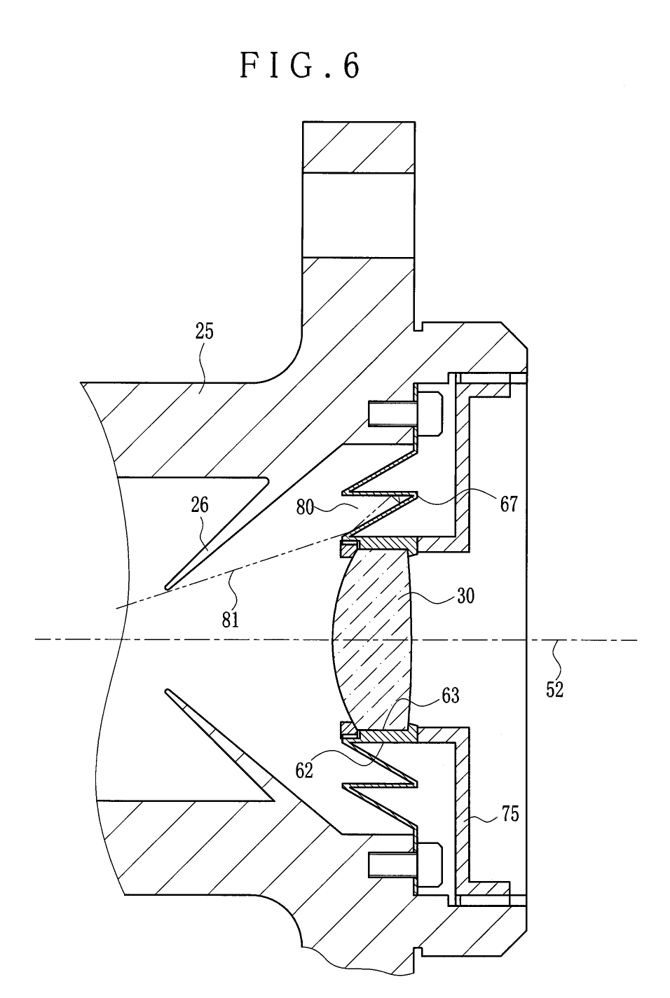

In FIG. 6, another preferred aperture wall 67 or aperture sheet for shielding light is illustrated. A lens holder 62 holds the lens/lens group 30 in the lens barrel. A light path 63 or inner wall extends through the lens holder 62. The aperture wall 67 supports the lens holder 62. A plurality of inclined surfaces are included in the aperture wall 67 in a corrugated form or bellows form, are arranged in belt shapes, and are inclined with different inclinations with respect to the optical axis 52. The aperture wall 67 extends from the inner wall disposed about the light path 63. The annular grooves 80 are defined between the inclined surfaces, and oriented to the entrance side. Stray light 81 upon entry in the annular grooves 80 is repeatedly reflected by the inclined surfaces and attenuated. Also, the aperture wall 67 absorbs shock and vibration applied externally, and maintains precision in positioning the lens/lens group 30.

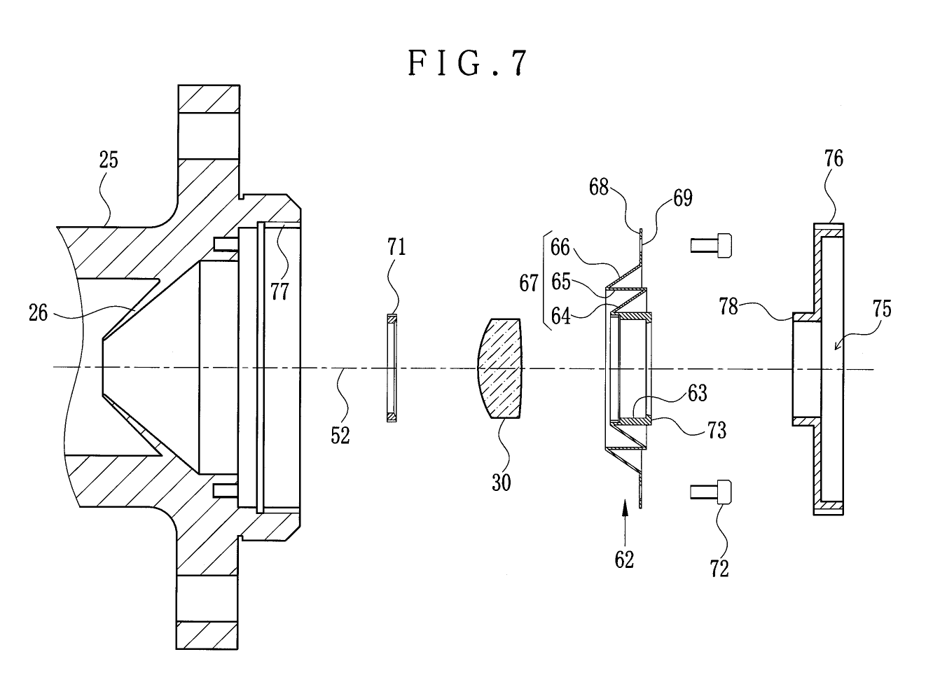

In FIG. 7, the aperture wall 67 is in a corrugated form or bellows form, and includes an inclined region 64, an annular region 65 and an inclined region 66. The inclined region 64 projects from a front edge of the light path 63 on the entrance side toward the exit side. The annular region 65 extends cylindrically from a rear edge of the inclined region 64 on the exit side toward the entrance side. The inclined region 66 projects from a front edge of the annular region 65 on the entrance side toward the exit side. The annular grooves 80 are defined by front surfaces of the inclined region 64 and the annular region 65. It is possible to arrange a plurality of the inclined regions 64 and a plurality of the annular regions 65 alternately. A flange wall 68 is formed on a rear edge of the inclined region 66 and extends in a direction perpendicular to the optical axis 52. Note that the annular region 65 may be not cylindrical and not in parallel with the optical axis 52. For example, the annular region 65 can have a conical shape with an inclination reverse to that of the inclined region 64. A front surface of the aperture wall 67 on the entrance side is finished with non-glossy matte finish.

A retaining ring 71 keeps the lens/lens group 30 positioned when inserted in the light path 63. Holes 69 are formed in the flange wall 68. A screw 72 is inserted in each of the holes 69, and fixes the lens holder 62 with the lens/lens group 30 on the barrel body 25. A male thread 76 is disposed on the periphery of a regulating ring 75. A female thread 77 is disposed on a rear end of the barrel body 25 on an exit side. The male thread 76 is helically engaged with the female thread 77. A press projection 78 is formed to project from the regulating ring 75. A holder end 73 is disposed on the lens holder 62. The press projection 78 contacts the holder end 73. The holder end 73 is positioned behind the flange wall 68 on the exit side, and pressed toward the entrance side by the press projection 78. Recovering force of the aperture wall 67 exerts force to the inner wall of the light path 63 to return to the exit side. The inner wall of the light path 63 in the lens holder 62 is pressed against the press projection 78 and positioned.

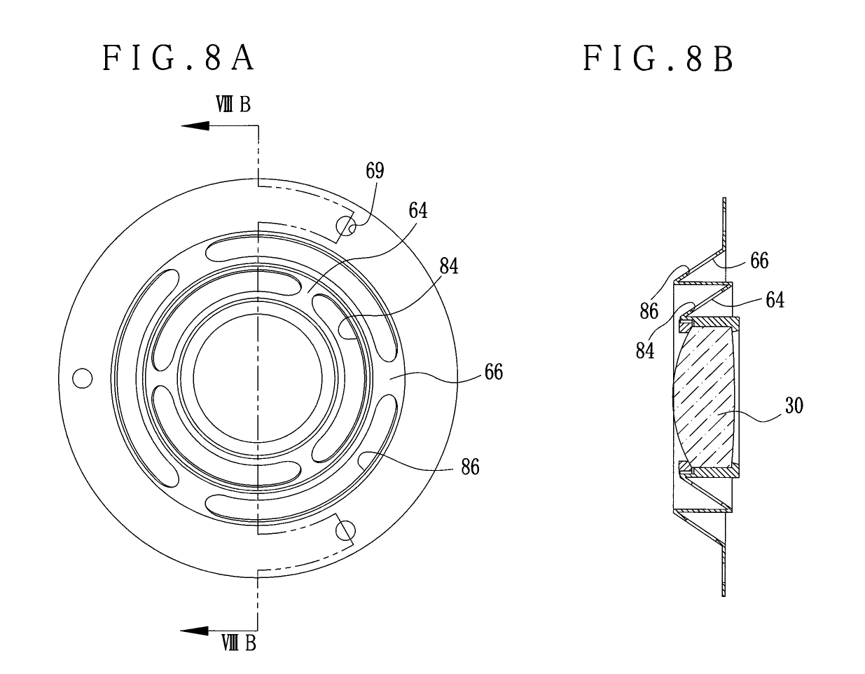

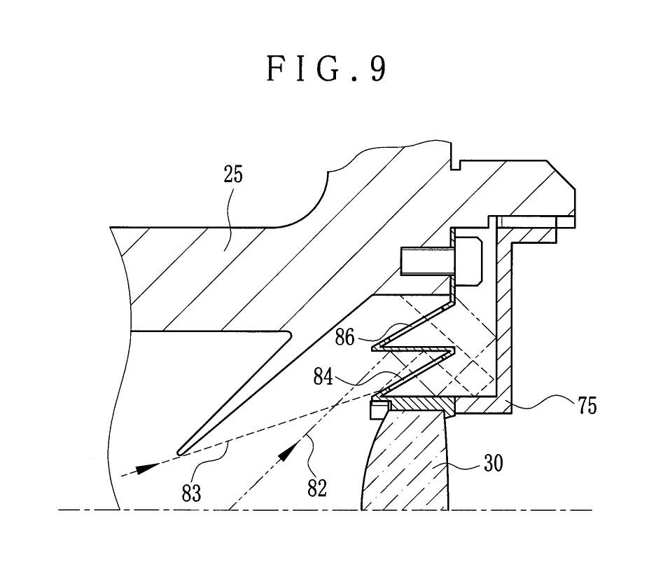

In FIGS. 8A and 8B, one preferred embodiment of the aperture wall 67 is illustrated. Through openings 84 and 86 are formed in the inclined regions 64 and 66. Even if the aperture wall 67 is formed from a plate with rigidity of metal, spring property of the aperture wall 67 can be maintained. In FIG. 9, stray light 82 passes through the through openings 84, and is scattered, reflected and attenuated between the lens holder 62 and the regulating ring 75. Even if stray light 83 exits from the through openings 84, the stray light 83 is very weak according to the repeated reflection.

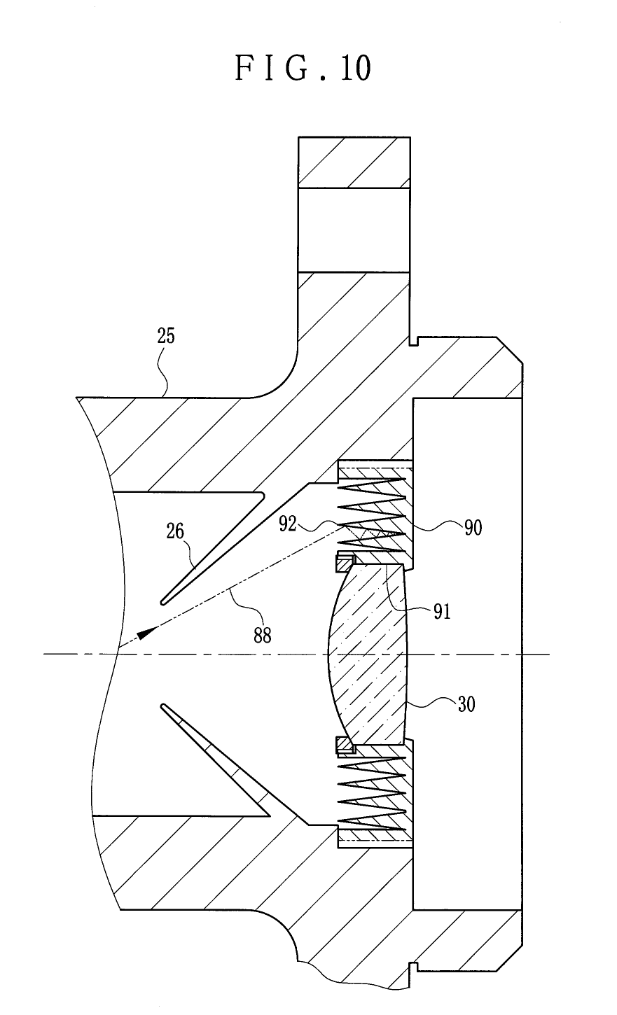

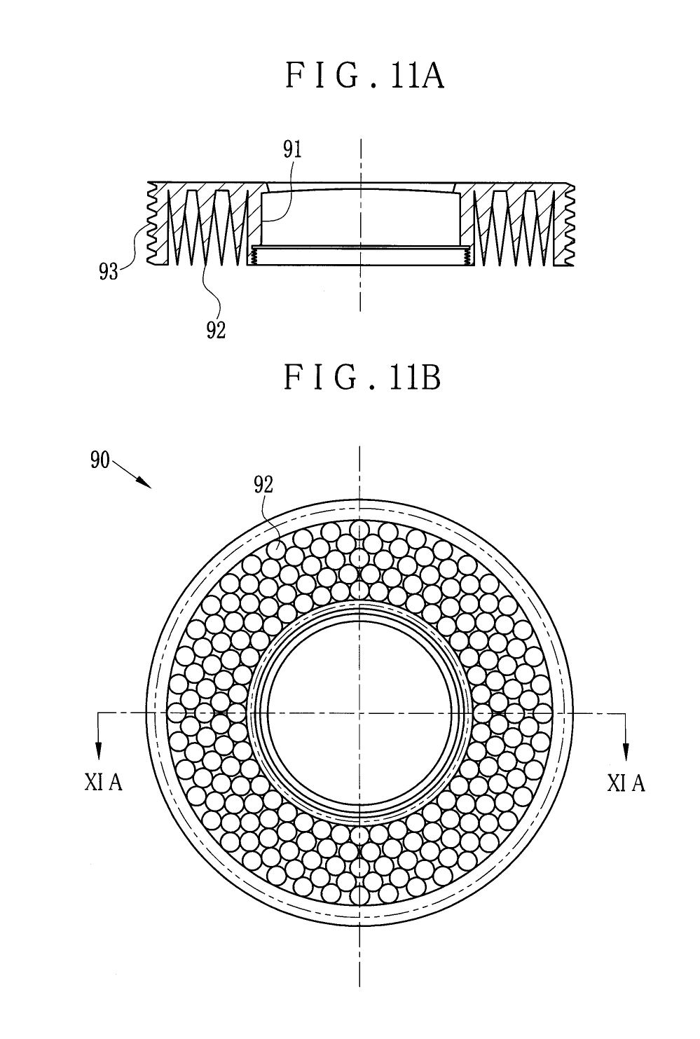

In FIG. 10, another preferred lens holder 90 is illustrated. Plural pin-shaped projections 92 patterned in a brush tooth configuration are arranged to project from the lens holder 90 which is fixed on the barrel body 25. In FIGS. 11A and 11B, a male thread 93 is formed on a peripheral surface of the lens holder 90, and helically engaged with a female thread formed with the barrel body 25. There is a light path 91 or inner wall, outside which the pin-shaped projections 92 are positioned to extend with a decreasing width. Gaps between the pin-shaped projections 92 are formed in a wedge shape as viewed in a section. Also, a surface of the pin-shaped projections 92 is finished with non-glossy matte finish. Stray light 88 in FIG. 10 upon entry in the wedge shaped gaps is repeatedly reflected by the pin-shaped projections 92 and attenuated.

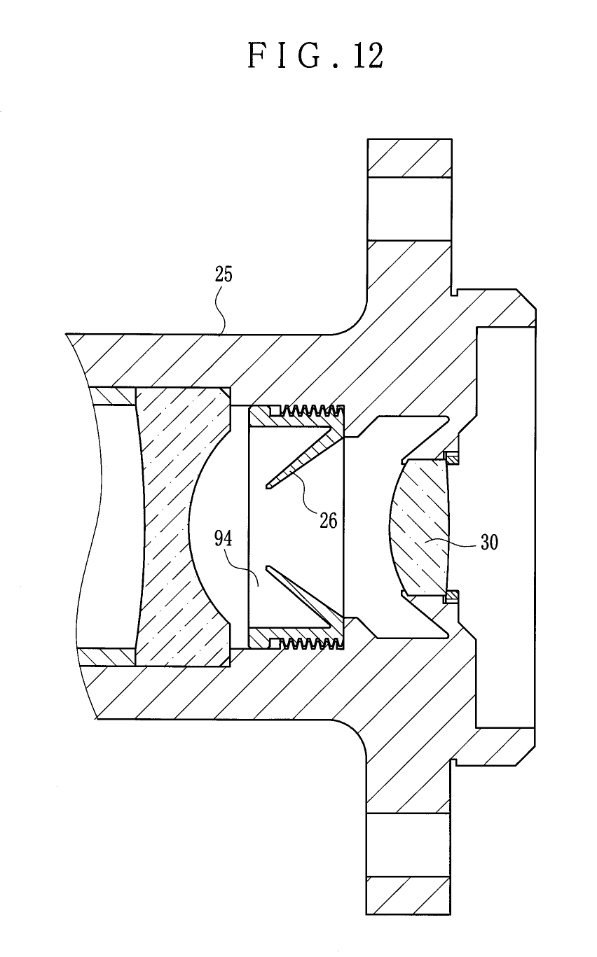

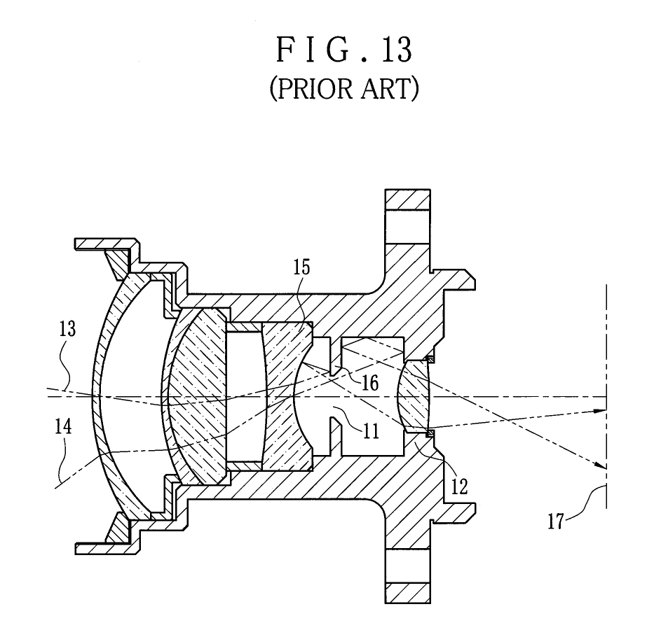

In FIG. 12, still another preferred embodiment is illustrated. An auxiliary sleeve 94 or aperture stop device is used to support the aperture wall 26, and is secured to the inside of the barrel body 25, instead of forming the aperture wall 26 with the barrel body 25 integrally. To secure the auxiliary sleeve 94 to the barrel body 25, it is possible to use helical engagement with threads, a press-fit structure, and the like.

In the above embodiments, the lens/lens group 30 is disposed behind the aperture wall 26 in combination with the lens holders 28, 62 and 90. However, lens/lens group in the invention can be disposed in front of the aperture wall 26 in combination with the lens holders 28, 62 and 90.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A lens barrel comprising:
a barrel body for containing a lens;
a first aperture wall, disposed in front of said lens, formed to project from an inner surface of said barrel body toward an optical axis of said lens, for defining a light path of incident light, and for light shielding outside said light path;
a first front surface formed on said first aperture wall on an entrance side annularly, and inclined with a decreasing diameter toward said entrance side with respect to said optical axis.

2. A lens barrel as defined in claim 1, wherein said first front surface is finished with non-glossy matte finish.

3. A lens barrel as defined in claim 1, further comprising a focusing lens, contained in said barrel body in front of said lens, wherein said first aperture wall is disposed between said lens and said focusing lens.

4. A lens barrel as defined in claim 1, further comprising a second aperture wall for light shielding between a periphery of said lens and said inner surface.

5. A lens barrel as defined in claim 4, further comprising a second front surface formed on said second aperture wall on said entrance side annularly, and inclined in a direction in which said first front surface is inclined.

6. A lens barrel as defined in claim 4, further comprising a second front surface formed on said second aperture wall on said entrance side annularly, and shaped in a locally bent form as viewed in a section;
wherein said second front surface has a combination of an annular surface aligned with said optical axis and an inclined surface inclined relative to said optical axis, or a combination of two inclined surfaces inclined relative to said optical axis in directions opposite to one another.

7. A lens barrel as defined in claim 6, wherein said second aperture wall is a corrugated sheet.

8. A lens barrel as defined in claim 7, further comprising:
a regulating ring, disposed behind said corrugated sheet, for firmly contacting an end of a support portion of said corrugated sheet for supporting said lens; and
a through opening, formed in said inclined surface, for causing attenuation of entered stray light between said regulating ring and said corrugated sheet.

9. A lens barrel as defined in claim 4, further comprising a plurality of pin-shaped projections, formed on a surface of said second aperture wall on said entrance side, and having a decreasing width toward said entrance side.

10. A lens barrel comprising:
a barrel body for containing a lens;
an aperture wall for defining a light path through a center of said barrel body, and for light shielding outside said light path;
a front surface formed on said aperture wall on an entrance side annularly, and inclined with a decreasing diameter toward said entrance side.

11. A lens barrel as defined in claim 10, wherein said front surface is finished with non-glossy matte finish.

12. A lens barrel comprising:
a barrel body for containing a lens;
an aperture wall for defining a light path through a center of said barrel body, and for light shielding outside said light path;
an annular front surface formed on said aperture wall on an entrance side annularly, and shaped in a locally bent form as viewed in a section;
wherein said annular front surface has a combination of an annular surface aligned with an optical axis and an inclined surface inclined relative to said optical axis, or a combination of two inclined surfaces inclined relative to said optical axis in directions opposite to one another.

13. A lens barrel as defined in claim 12, wherein said aperture wall is a corrugated sheet.

14. A lens barrel as defined in claim 13, wherein said annular front surface is finished with non-glossy matte finish.

15. A lens barrel comprising:
a barrel body for containing a lens;
an aperture wall for defining a light path through a center of said barrel body, and for light shielding outside said light path; and
a plurality of pin-shaped projections, formed on a surface of said aperture wall on an entrance side, and having a decreasing width toward said entrance side.

16. A lens barrel as defined in claim 15, wherein said pin-shaped projections have a surface finished with non-glossy matte finish.
